(19) United States
(12) Patent Application Publication
(10) Pub. No.: US 2005/0073252 A1
(43) Pub. Date: Apr. 7, 2005

(54) Halogen bulb

(76) Inventors: Akinori Ohashi, Hyogo (JP); Katsumi Kuwata, Hyogo (JP); Katsumi Nakamori, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/954,278

(22) Filed: Oct. 1, 2004

(30) Foreign Application Priority Data
Oct. 3, 2003 (JP) 2003-345578

(51) Int. Cl. H01K 1/50

(52) U.S. Cl. 313/579

(57) ABSTRACT

A halogen bulb comprises an arc tube, a filament provided in the arc tube, comprising a wire having a first end and a second end, first and second wire lead-out portions connected to the first end and the second end of the wire respectively, a first internal lead rod having a first tip portion and a second internal lead rod having a second tip portion, connected to the first and second wire lead-out portions respectively by welding, and wherein a first angle at which the first tip portion of the first internal lead rod inclines from a first direction in which the first wire lead-out portion extends, is approximately the same as a second angle at which the second tip portion of the second internal lead rod inclines from a second direction in which the second wire lead-out portion extends.

### FIELD OF THE INVENTION

This invention relates to a halogen bulb for a headlight of a car which is called H7, H8, H9, and H11, for example, in the ECE rule.

### DESCRIPTION OF THE RELATED ART

In the regulation of a halogen bulb which is installed in a headlight fitting of a car, the position of a filament to a base portion is restricted, and further halogen bulbs are classified into H1, H2, H3, H4, H5, H6, H7, H8, H9, H11, etc. according to the difference in a size, form, a terminal, etc.

FIG. 2 is a front and partially perspective view, wherein a H7 type halogen bulb lamp is seen from a flat face of a pinch seal portion.

A lamp 60 is a halogen lamp, one end of which is sealed, wherein a pinch seal 62 is formed at one end of an arc tube 61, and a coil-like filament 63 is provided in the arc tube so that the filament 63 is in parallel to the axis L of the arc tube. Internal lead rods 64a and 64b which are made of metal such as molybdenum, are connected, by welding, to both lead-out portions 63a and 63b of the filament 63 through sleeves 65a and 65b made of molybdenum respectively. The internal lead rods 64a and 64b are disposed symmetrically with respect to the center axis L of the arc tube 61, and the other ends of the respective internal lead rods 64a and 64b are drawn through the above-mentioned pinch seal section 62. Moreover, as shown in this figure, a tip portion 66, which is a remnant of an exhaust pipe, is formed in the top part of the arc tube 61. A predetermined base portion (not shown) is attached to such a halogen lamp 60, thereby serving as a halogen bulb for a car.

In the specification of the H7 type halogen bulb for a car, it is specified that in the front elevational view of the lamp shown in FIG. 2, concretely speaking, viewing from the flat face side of the pinch seal portion 62, a gap width d between the center axis L of the arc tube 61 and the axis F of the filament 63 is set to 0.5 mm or more and metal is not placed in the predetermined space (non-metal zone) in the arc tube.

Namely, metal is not placed in a space which is in the right hand side of diagonal lines shown in FIG. 2 and which is perpendicular to the paper inside the arc tube. More specifically, when a point on the filament axis F, which is located downward at a distance of 3 mm from the lower edge of the filament 63 is made into a reference point O, the metal is not placed in an space (area) surrounded by the filament axis F and a perpendicular line P drawn rightward of the filament axis F from the reference point O and a space (area) located within an angle of 50 degrees or less with respect to the reference point O from the perpendicular line P.

Furthermore, such a halogen bulb for a care needs to possess the reliability as a lamp, and the following are required.

First, it is necessary to secure an insulation distance A between the internal lead rod 64a and the other internal lead rod 64b, to prevent short circuit therebetween. For this reason, a first crooked section 641 is formed so that the internal lead rod 64a is kept away from the filament 62. Moreover, a second crooked portion 642 is formed as if the second crooked portion 642 is folded back to a place distant from the first crooked portion 641 by a predetermined distance so that the lead-out portion of the filament 63 and an inner wall of the arc tube 61 are not in contact with each other. That is a distance B is secured. Moreover, it is necessary to suppress thermal influence from the filament 63 on the internal lead rod 64.

For this reason, the angle which turns inward in the second crooked portion 642 is suppressed to comparatively small, a distance C is provided between the filament 63 and a portion of the internal lead rod 64a which is located near the middle portion of the filament 63, so that the internal lead rod 64a is disposed at a distance from the filament 63.

Furthermore, the leading-out method of the wire of the filament 63 is also limited. That is, although the diameter of the wire (or naked wire) of the filament 63 is very small so that the wire is fragile, for example the wire diameter is φ0.15 mm, it is necessary to have as high vibratility-proof for the use as possible, but it is not desirable to remarkably deviate it from the coil winding direction of the filament 63 or to extend the lead-out portion.

And the internal lead rods 64a and 64b connected to the wire will also receive the restrictions by the above-mentioned “non-metal zone.” Therefore, the wire is pulled out mostly in the direction of a tangent to the coil at the lead-out portion 63a of the filament 63, and at the other lead-out portion 63b, the wire is pulled out in the tangent direction and then taken out approximately in parallel to the filament axis F with curvature wherein the length thereof is determined so as to be relatively short.

Consequently, it is required that an crooked angle of the crooked portion 643 of the other internal lead rod 64b be set to 120 degrees or more, and in order to secure the “non-metal zone,” the angle is set in the range of 140 or less degrees.

As mentioned above, the specification of each part of the filament and the internal lead rods is strictly subject to the various restrictions. Refer to Japanese Registered Utility Model No. 2581773.

### SUMMARY OF THE INVENTION

However, the following problems occur in the above-mentioned halogen bulb for a car.

Although, as mentioned above, the leading-out direction of the wire of the filament is mostly restrictive at the both end of the filament, and the crooked portion(s) is formed near the tip portion of the respective internal lead rod(s), and the pair of internal lead rods inclines in a particular direction, in order to satisfy the various restriction, each of the internal lead rods differs with respect to the gradient angle to the lead-out direction of the filament, so that a difference in a contact area arises between welding portions.

For example, a concrete numerical value of the gradient angle of the internal lead rods, is about 76 degrees for one of the lead-out portions of the filament, and 40 to 60 degrees for the other lead-out portion so that a big difference arises.

Consequently, since the welding strength differs between the welding portions, in the side with smaller strength, the junction tends to break, thereby stopping electric supply within the life period of the filament so that the lamp is not lighted.

In order to solve these problems, a measure is considered to be taken variously, such as changing the equipments for welding or changing the shape of the sleeves which are provided in the welding portions. However, since workability will be markedly deteriorated so that the production cost will also increase sharply in that case, realization thereof is actually impossible.

In a halogen lamp used for a car, since the full length of a filament is as small as about 4.5 mm, a single welding machine is in general used in order to weld the filament and the pair of internal lead rods respectively, in a welding process.

Consequently, since the welding strength of the welding portions differs from each other, when welding is carried out according to one side, problems such as poor welding and a lead rod crease occur in the other side. That is, the firm junctions between the filament and the respective internal lead rods cannot be acquired at the both ends of the filament.

In view of the above problems, it is an object of the present invention to offer a halogen bulb.

It is another object of the present invention to provide a halogen bulb which can be suitably used for a car, wherein the standard and/or other restrictions are satisfied without reducing manufacturing efficiency.

Further, it is still another object of the present invention to provide a halogen bulb which can be suitably used for a car wherein it is possible to increase junction strength in welding portions of a filament and internal lead rods at both ends.

The objects of the present invention is accomplished by a halogen bulb for a car comprising an arc tube, a filament provided in the arc tube, and first and second internal lead rods provided in an arc tube, wherein a tip portion is formed at a first end portion of the halogen bulb and a pinch seal portion is provided at a second end portion of the halogen bulb, a center axis of the filament is in parallel to a center axis of the arc tube, the first and second internal lead rods extend in parallel to a center axis of the arc tube from the pinch seal portion, and the first and second internal rods are welded to a first end and a second end of a filament wire drawn from of the filament respectively, and wherein a first angle at which a first tip portion of a first internal lead rod inclines from a first direction in which a first wire lead-out portion extends, is approximately the same as a second angle at which a second tip portion of a second internal lead rod inclines from a second direction in which a second wire lead-out portion extends. Since the tip portions of one and the other internal lead rods incline at approximately the same angle as each other with respect to the extending direction of the wire lead-out portions led out from one end and the other end of the filament, at the both end of the filament, it is possible that an area of the welding portion of each internal lead rod and the wire can be made approximately the same, so that it is possible to make the strength of the junction portion approximately the same (equivalent). Therefore, it is possible to acquire a firm junction state between the filament and the internal lead rods at the both ends of the filament, whereby a connection state of the welding portions for the wire of the filament and the internal lead rods can be maintained stably, and it is possible to provide a halogen bulb for a car in which it is possible to avoid the problem that the lamp cannot be lighted in an early date. Of course, since the strength of the junction portions can be made almost equal on one side and the other side even when a single welding machine performs junction of the filament and the internal lead rods, it is possible to simply perform welding operation without deteriorating the efficiency of the welding operation.

In the halogen bulb, three crooked portions may be formed in the first internal lead rod connected to the filament wire. Since three crooked portions are provided in the tip section of the internal lead rod joined to the lead-out portion on the side of the tip portion of the filament wire, short circuit between the internal lead rods can be avoided, and contact between the arc tube and the filament lead-out portion can be avoided, so that it is possible to provide a halogen bulb for a car which has high reliability and which can reduce thermal influence on the internal lead rods from the filament.

In the halogen bulb for a car, the first angle may be approximately 60 degrees. Since the internal lead rods incline at approximately 60 degrees to the direction in which each wire lead-out portion extends, it is possible to provide a halogen bulb wherein specification which is defined by the strict standard for car uses is satisfied.

### BRIEF DESCRIPTION OF THE DRAWINGS

FIG. 1 is a explanatory front view of a lamp portion of a halogen bulb for a car according to the present invention; and

FIG. 2 is an explanatory front view of a lamp portion of a conventional halogen lamp for a care.

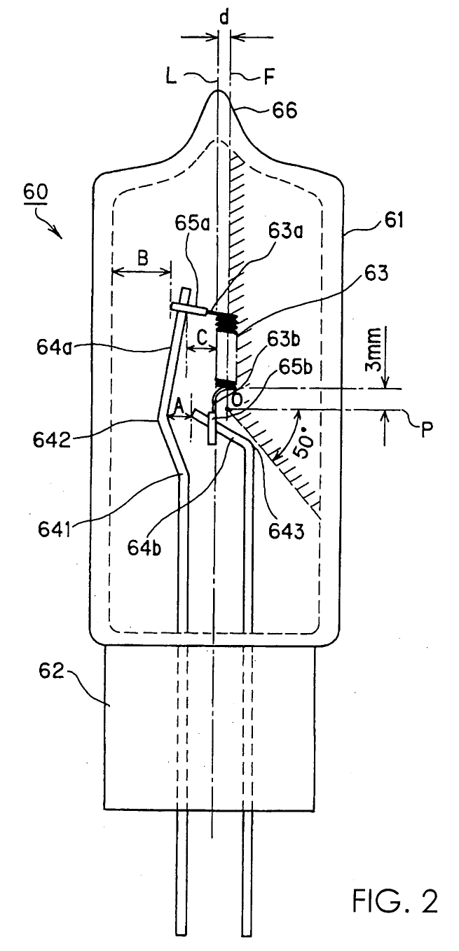

### DESCRIPTION OF THE PREFERRED EMBODIMENTS

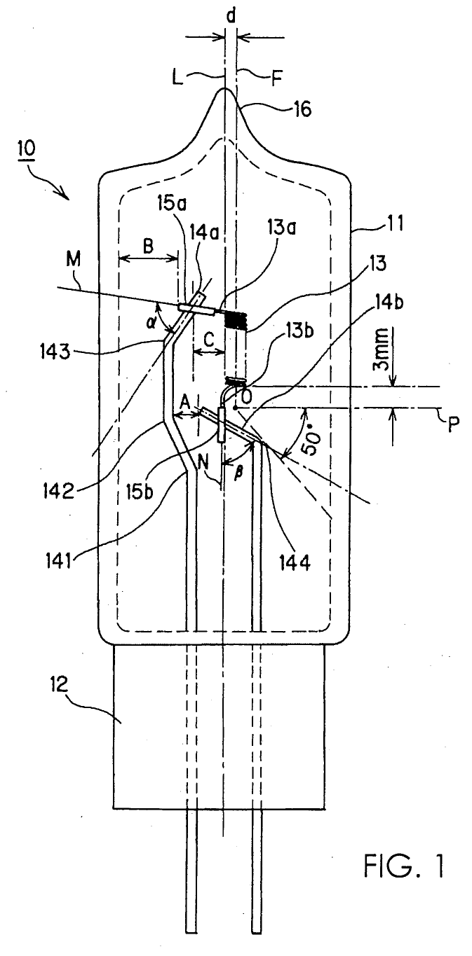

FIG. 1 is an explanatory front elevational view of a halogen bulb for a car according to an embodiment of the present invention, showing only a lamp portion thereof, which is specifically seen from a pinch seal portion side.

In FIG. 1, a lamp 10 comprises a halogen lamp, one end of which is sealed, wherein a pinch seal portion 12 is formed at one end of an arc tube 11 made of quartz glass. The lamp 10 for a halogen bulb for a car is classified as H7 by the ECE regulation. A filament 13 is confined in the arc tube wherein it is in parallel to the axis of the arc tube. Further, halogen gas and inert gas or nitrogen gas etc. is enclosed in the arc tube.

The filament 13 is welded and held at a pair of internal lead rods 14a and 14b made of, for example, molybdenum through sleeves 15a and 15b made of molybdenum, which are provided at lead-out portions 13a and 13b of the filament 13, respectively. The internal lead rods 14a and 14b are pulled out through the pinch seal section 12.

In addition, a tip portion 16, which is a remnant of an exhaust pipe, is formed at an end portion on the side opposite to the pinch seal section 12 in the arc tube 11. A predetermined base portion (not shown) is attached to such a halogen lamp 10, so that it is used as a halogen bulb for a car.

In this figure, the axis F of the filament 13 is arranged in parallel to the center axis L of the arc tube 11 and is distant from the axis L by a width d of 0.5 mm or more. A wire of the filament 13 is drawn at both ends, wherein one of the lead-out portions 13a on the side of the tip portion 16 is drawn in the tangent direction of a filament coil, and the other lead-out portion 13b is drawn in the tangent direction of the coil, curved a little and drawn in parallel to the axis F of a filament.

Metal is not placed in an area perpendicular to the paper and surrounded by the filament axis F, the reference point O and a perpendicular line P drawn rightward from the filament axis F, inside the arc tube, and an area located within an angle of 50 degrees or less with respect to the reference point O from the perpendicular line P, when a point on the filament axis F, which is located downward at a distance of 3 mm from the lower edge of the filament 63 is made into a reference point O.

Three crooked portions 141, 142, and 143 are formed in the internal lead rod 14a, which is connected to the lead-out portion 13a of the filament 13. The internal lead rod 14a projects from the pinch seal portion 12, extends in parallel to the center axis L of the arc tube 11 and then is bended at a first crooked portion 141 so as to extend away from the filament 13. A second crooked portion 142 is formed at a certain distance from the first crooked portion 141 in the internal lead rod 14a, and the lead rod 14a extends approximately in parallel to a tube wall of the arc tube 11 in a section between the second crooked portion 142 and a third crooked portion 143. And the internal lead rod 14a is bended in a direction which approaches the filament 13 at the third crooked portion 143, and intersects with a sleeve 15a which is connected to the lead-out portion 13a of the filament 13.

An angle α (alpha) formed by the tip portion of the internal lead rod 14a and a virtual line M which is parallel to a direction in which the wire pulled out on the lead-out portion 13a extends, is set to approximately 60 degrees. In this embodiment, the “approximately 60 degrees” means but is not limited to 60±5 degrees (55 to 65 degrees).

Moreover, the internal lead rod 14b connected to the other lead-out portion 13b of the filament 13 is crooked in a direction to the filament 13 at a crooked portion 144.

In this embodiment, an angle β (beta) formed by a tip portion of the internal lead rod 14b and a virtual line N which is parallel to the direction in which the wire drawn on lead-out portion 13a extends, is set to 60 degrees. In this embodiment, the “60 degrees” means but is not limited to 60±5 degrees (55 to 65 degrees).

The angle α (alpha) formed by the tip portion of the internal lead rod 14a and the line extending from the other wire lead-out portion 13a is set so as to be approximately equal to the angle β (beta) formed by the tip portion of the internal lead rod 14b and the line extending from the wire lead-out portion 13b.

In this embodiment, “the angle α (alpha) is approximately equal to the angle β (beta)” means that difference therebetween is 5 degrees or less.

If the range is satisfied, it is possible to reduce the strength difference in the welding portions at both end of the filament so that the difference is so small that it can be ignored.

In this embodiment, the smaller the difference between these angles alpha and beta, the more the effect is acquired. The difference between these angles alpha and beta is preferably 3 or less degrees, more preferably 1 or less degree.

According to the present invention, since the lead-outs portion 13a and 13b of the filament 13, and the internal lead rods 14a and 14b which are welded corresponding to the respective lead out portions 13a and 13b are intersected at substantially the same angle at the both side of the filament, the areas of welding portions formed at both ends of the filament 13 where the internal lead rods 14a and 14b are welded are made to approximately equal to each other so that even though they are welded by a single welding machine, it is possible to make the strength of welding portion at the both side approximately equal.

Consequently, it becomes possible to make the strength of the welding portions high at the both ends of the filament 13, so that the junction state of the filament 13 and the internal lead rods 14a and 14b can prevent the problem that only one of them breaks easily, and it is possible to avoid the problem that the lamp 10 is not lighted because of breakage of one of the internal lead rods 14a and 14b at an early stage.

In addition, although the metal sleeves 15a and 15b are placed between the internal lead rods and the wire in the above described structure, since the direction in which the sleeves 15a and 15b are provided is substantially identical to the direction in which the wire lead-out portions 13a and 13b of the filament 13 extend, respectively, if the angle alpha formed by the tip portion of the internal lead rod 14a and the vertical line M drawn on the wire lead-out portion 13a, and the angle beta formed by the tip portion of the internal lead rod 14b and the vertical line N drawn on the lead-out portion 13b of the wire are made almost the same, both junction portion areas can be made almost the same.

Furthermore, according to the halogen lamp in the above-mentioned structure, since the three crooked portions are formed in a portion of the internal lead rod 14a between the junction portion of the filament 13 and the pinch seal portion, requirements set forth below are satisfied, and high reliability is secured. That is, an insulation distance A between the internal lead rods 14a and 14b (or the filament 13) can be secured, and a short circuit between the internal lead rods 14a and 14b (filament) can be prevented.

Since a space B is formed, the distance between the inner wall of the arc tube 11 and the internal lead rod 14a is secured, and further the inner wall of the arc tube 11 and the lead-out portion 13a of the filament 13 or the sleeve 15a connected to the lead-out portion 13a are not in contact with each other.

Moreover, since a space C is formed, necessary distance between the internal lead rod 14a and the filaments 13 is secured, so that thermal influence on the internal lead rod 14a can be made small.

Furthermore, since the internal lead rods 14a and 14b incline at an angle of approximately 60 degrees from the lead-out portions 13a and 13b of the filament wire, respectively and welded,

In the standard concerning lamps for cars, it is possible to provide a halogen lamp which satisfies the regulation concerning the position of a filament 13 and an arc tube 11.

As described above, according to the present invention, since the angle at which the tip portion of one of the internal lead rods inclines from the (vertical) line extending from one of the wire lead-out portions of the filament, is almost the same as the angle at which the tip portion of the other internal lead rod inclines from the (vertical) line extending from the other wire lead-out portion, at the both end of the filament, the welding portion areas where the both internal lead rods and the filament wire or sleeve are welded respectively are made approximately equal so that the strength of the welding portions in the filament can be made the same.

As a result, it is possible to increase the strength of the welding portions at the both end of the filament, thereby preventing the problem that the junction of only one of the internal lead rods and the filament breaks easily so that it is possible to avoid the problem that the lamp is not lighted at the early stage and further, since it is possible to make the difference of the strength in the welding portions small even though a single welding machine is used, a halogen bulb for a care having a high productivity can be offered.

Furthermore, it is possible to provide a halogen bulb for a car possessing high reliability by forming the three crooked portions in the internal lead rod connected to the wire drawn from the tip portion side end of the filament.

Furthermore, it is possible to provide a halogen bulb for a car, which satisfies the strict standard concerning a halogen lamp for a car, by setting the angle at which the internal lead rod inclines from the direction in which the wire lead-out portion of the filament extends, to about 60 degrees.

Although the present invention is explained referring to the embodiments, the present invention is not limited to the above-mentioned embodiments but it is possible to change the structure.

Moreover, in the above description of the present invention, although each part of the structure is explained based on the so-called H7 halogen bulb for a car, the present invention can be applied suitably for other types of a halogen bulbs for a car, such as H8, H9, H11 and so on, in which the so-called “non-metal zone” was specified. Moreover, the material etc. of each part can be suitably changed. Thus the present invention possesses a number of advantages or purposes, and there is no requirement that every claim directed to that invention be limited to encompass all of them.

The disclosure of Japanese Patent Application No. 2003-345578 filed on Oct. 3, 2003 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A halogen bulb for a car comprising:
an arc tube,
a filament provided in the arc tube, and
first and second internal lead rods provided in the arc tube,
wherein a tip portion is formed at a first end portion of the halogen bulb and a pinch seal portion is provided at a second end portion of the halogen bulb, a center axis of the filament is in parallel to a center axis of the arc tube, the first and second internal lead rods extend in parallel to a center axis of the arc tube from the pinch seal portion, and the first and second internal rods are welded to a first end and a second end of a filament wire drawn from of the filament respectively, and
wherein a first angle at which a first tip portion of a first internal lead rod inclines from a first direction in which a first wire lead-out portion extends, is approximately the same as a second angle at which a second tip portion of a second internal lead rod inclines from a second direction in which a second wire lead-out portion extends.

2. The halogen bulb for a car according to claim 1, wherein three crooked portions are formed in the first internal lead rod connected to the filament wire.

3. The halogen bulb for a car according to claim 1, wherein the first angle is approximately 60 degrees.

4. The halogen bulb for a car according to claim 2, wherein the first angle is approximately 60 degrees.

5. The halogen bulb for a car according to claim 1, wherein difference between the first angle and the second angle is 3 degrees or less.

6. The halogen bulb for a car according to claim 5, wherein the difference is 1 degree or less.

7. The halogen bulb for a car according to claim 2, wherein difference between the first angle and the second angle is 3 degrees or less.

8. The halogen bulb for a car according to claim 7, wherein the difference is 1 degree or less.

9. The halogen bulb for a car according to claim 1, wherein a first area where the first lead-out portion and the first internal lead rod are welded and a second area where the second lead-out portion and the second internal lead rod are welded are approximately the same.

10. The halogen bulb for a car according to claim 2, wherein a first area where the first lead-out portion and the first internal lead rod are welded and a second area where the second lead-out portion and the second internal lead rod are welded are approximately the same.

11. A halogen bulb comprising:
an arc tube,
a filament provided in the arc tube, comprising a wire having a first end and a second end,
first and second wire lead-out portions connected to the first end and the second end of the wire respectively,
a first internal lead rod having a first tip portion and a second internal lead rod having a second tip portion, connected to the first and second wire lead-out portions respectively by welding, and
wherein a first angle at which the first tip portion of the first internal lead rod inclines from a first direction in which the first wire lead-out portion extends, is approximately the same as a second angle at which the second tip portion of the second internal lead rod inclines from a second direction in which the second wire lead-out portion extends,
whereby a first area where the first lead-out portion and the first internal lead rod are welded and a second area where the second lead-out portion and the second internal lead rod are welded are approximately the same.

12. The halogen bulb according to claim 11, wherein three crooked portions are formed in the first internal lead rod connected to the filament wire.

13. The halogen bulb according to claim 11, wherein the first angle is approximately 60 degrees.

14. The halogen bulb according to claim 11, wherein difference between the first angle and the second angle is 3 degrees or less.

15. The halogen bulb according to claim 14, wherein the difference is 1 degree or less.

16. The halogen bulb according to claim 11, wherein a first area where the first lead-out portion and the first internal lead rod are welded and a second area where the second lead-out portion and the second internal lead rod are welded are approximately the same.

17. The halogen bulb according to claim 11 wherein the first and second internal lead rods are made of molybdenum.

18. The halogen bulb according to claim 11 wherein the first and second internal lead rods are connected to the first and second lead-out portions of the filament through first and second sleeves respectively.
